(19) United States
(12) Patent Application Publication
(10) Pub. No.: US 2005/0081979 A1
(43) Pub. Date: Apr. 21, 2005

(54) Method for vibration welding with reduced attenuation time

(75) Inventors: Jorg Vetter, Rodgau (DE); Heiko Priem, Brachtal/Hellstein (DE)

Correspondence Address: WALL MARJAMA & BILINSKI, 101 SOUTH SALINA STREET, SUITE 400, SYRACUSE, NY, 13202, US

(73) Assignee: Branson Ultraschall Niederlassung der Emerson Technologies GmbH & Co.

(21) Appl. No.: 10/963,066

(22) Filed: Oct. 12, 2004

(30) Foreign Application Priority Data
Oct. 15, 2003 (DE) 103 47 984.8

(51) Int. Cl. B32B 31/16

(52) U.S. Cl. 156/73.6

(57) ABSTRACT

In a method for linear or biaxial vibration welding, the attenuation time of oscillatory relative movements of the welding parts is reduced in a control manner as compared to the attenuation time obtained by free uncontrolled attenuation of the welding parts so as to improve the mechanical properties of the welding seam. Preferably, the attenuation time is reduced by active braking of the oscillatory relative movements of the welding parts. The active braking may be obtained in various ways, preferably by using an electromagnetic resonance vibration system.

### BACKGROUND OF THE INVENTION

The present invention relates to a method for vibration welding, in particular for linear or biaxial (planar) vibration welding of welding parts made of similar or related thermoplastic materials or of welding parts of different materials, in particular made of a thermoplastic material and another meltable plastic material.

This type ofvibration welding is well known and widely used in industry. Actual research and development work has concentrated on the welding of duroplastic welding parts, on the welding of filled thermoplastic materials, on the combination of the welding operations and radiation heating of the welding parts at their welding surfaces, and on the on-line quality evaluation for reducing or avoiding destructive testing. The welding properties, i.e. the mechanical properties of the welding seam, have also been the subject of research and development work. The obtainable welding quality is limited to the matrix resistance strength of the used materials, varies however in particular with complex shaped parts of fibre reinforced materials—as used for example in the automotive industry—due to material anisotrophies (fibre distribution and orientation) and local welding pressure differences (draft problems). Substantial improvements have been achieved by computer based product design and simulation, use of viscous thermoplastic materials, and pressure responsive process control (high pressure start-up). However, further improvements are desirable.

### SUMMARY OF THE INVENTION

It is a primary object of the present invention to provide a method for vibration welding wherein the mechanical properties of the welding seam of the welding parts are improved by acting upon the oscillatory relative movements of the welding parts.

The method for vibration welding in accordance with the present invention has been defined in claim 1.

In accordance with the present invention the attenuation time of the oscillatory relative movements of the welding parts is reduced in a controlled manner as compared to the attenuation time obtained when the oscillatory relative movements of the welding parts are allowed to freely attenuate in an uncontrolled manner. In contrast to conventional vibration welding wherein the oscillatory relative movements of the welding parts are decelerated only by friction within the vibration system and damping effects in the molten layer of the welding seam of the welding parts, the method of the present invention provides for controlled and active reduction of the attenuation time. As a result thereof the mechanical properties of the welding seam are dramatically improved as was found in tests. In particular the invention provides for increased tensile strength and increased bursting strength of container-type welding parts.

The inventors assume that improvement of the mechanical properties of the welding seam results from the fact that the molten layer in the welding gap of the welding parts, which is cooled and solidified after stopping the vibratory drive, is less affected or disturbed due to the reduced attenuation time. As a result of relatively long attenuation times solidified melting zones may be broken up again thereby weakening the welding seam. Due to the reduced attenuation time such phenomena do not occur any more or at least less often. Furthermore, microscopic structure analysis of part crystalline thermoplastic welding parts have revealed a significantly changed morphology resulting form shear loads during the cooling phase being reduced due to the reduced attenuation time and being responsible for the improved mechanical properties of the welding seam.

In accordance with the invention, the attenuation time is preferably less than 100 ms and in particular less than 50 ms. Reduction of the attenuation time may be obtained by active braking of the oscillatory relative movements of the welding parts. When an electromagnetic resonance vibration system is used for the vibration welding operation, reduction of the attenuation time may be obtained by a reversal of the phase of vibration excitation or by controlling the amplitude or the position or path of movements of the vibration head of the welding machine. When a mechanical vibration system including a motor drive with control means is used, active braking of the oscillatory relative movements of the welding parts may be obtained by causing the control means act upon the motor drive. A further possibility is the use of a mechanical brake for braking the welding tool and/or the welding head and/or the motor drive of the mechanical welding system.

Further advantageous developments and modifications of the invention have been defined in the dependent claims.

### BRIEF DESCRIPTION OF THE DRAWINGS

In the drawings which illustrate the best mode presently contemplated for carrying out the invention:

FIG. 1 shows the structure of a welding machine for vibration welding in a very schematic manner;

FIG. 2 are diagrams for representing the vibration operation in a vibration welding machine;

FIG. 3 are diagrams for representing the oscillatory relative movements of a sample part during vibration welding;

FIG. 4 is a top view of the sample which has been welded by vibration welding;

FIG. 5 is sectional view taken in the direction of arrows A-A in FIG. 4;

FIG. 6 includes diagrams for representing the tensile strength and bursting strength of the sample part in response to the attenuation time.

### DETAILED DESCRIPTION

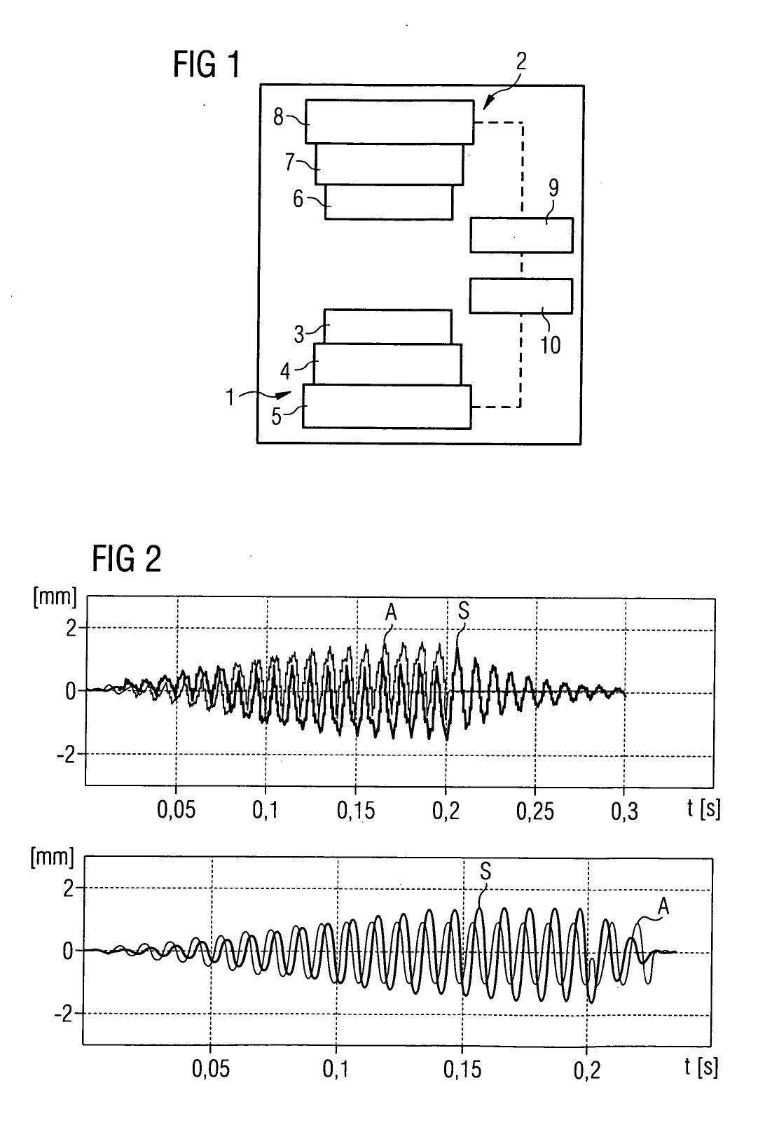

FIG. 1 shows, in a very schematic manner, the basic design of a welding machine for vibration welding including a stationary lower machine section 1 and an upper machine section comprising a vibration head 2. The lower machine section 1 comprises a lower receiving tool 3, a lift table 4, and lifting means 5. The vibration head 2 comprises an upper receiving tool 6, a clamping plate 7, and an electromagnetic drive 8. Furthermore, the welding machine comprises a generator 9 and control means 10 for the electromagnetic drive 8.

For performing a welding operation the welding parts (not shown) to be welded are fixed within the upper and, respectively, lower receiving tools 3, 6. The welding parts are urged into contact to each other at welding surfaces under predetermined welding pressure by means of the vertically movable lift table 4 and are driven to perform oscillatory relative movements by means of the vibration head 2 whereby the welding parts are molten in a welding zone. When the electromagnetic drive 8 is switched off, the welding parts will come to rest within a certain attenuation time. The molten material will cool and solidify so as to form a welding seam joining the welding parts.

The vibration operation of a conventional vibration welding machine is shown in the upper diagram of FIG. 2. Curve A represents excitation vibrations of the electromagnetic drive 8, and curve S represents the oscillatory movements of the welding part (not shown) retained within the upper receiving tool 6. As already mentioned above, in a conventional vibration welding machine only friction within the vibration system and damping effects within the molten layer decelerate the oscillatory relative movements of the welding parts. As shown in the upper diagram of FIG. 2, attenuation of the oscillatory relative movements occurs between about 0.2 and 0.35 s; therefore the attenuation time is about 150 ms.

Comparative tests on conventional vibration welding machines have shown that presently attainable attenuation times are in the range from 150 ms to 500 ms. The attenuation times vary in response to the type of material, the design of welding seam, the dimensions of the welding parts, the type of the welding machine, and process parameters. It appears that they are relatively independent of the type of the drive system used in the respective welding machine.

The method of the present invention reduces the attenuation time in a controlled manner. This is obtained by active braking of the vibration operation, for example by reversing the phase of the excitation vibrations (curve A) by the electromagnetic drive 8 in a vibration welding machine as shown in FIG. 1. This is shown in the lower diagram of FIG. 2 by curve A where a phase reversal has been caused shortly before the time 0.2 s. As a result the attenuation time of curve S is about 50 ms.

In accordance with the invention the attenuation time should be less than 100 ms and preferably in the order of 50 ms or even less.

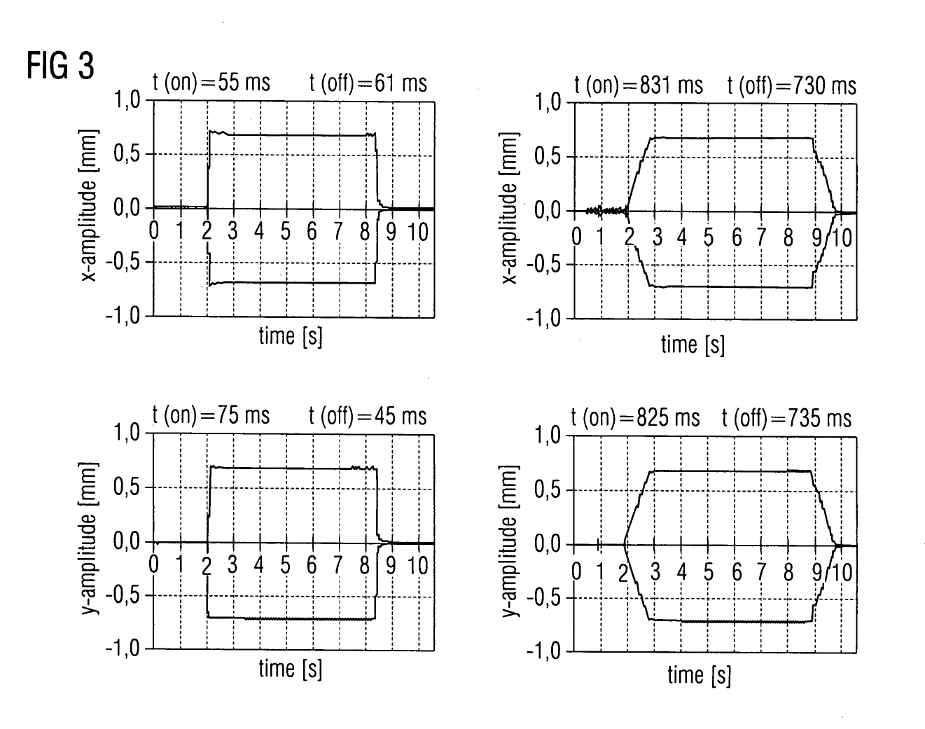

The diagrams of FIG. 3 shows the behaviour of the amplitude of the oscillatory relative movements during biaxial vibration welding of complex sample parts of polypropylene as measured by the inventors; the curves of the diagrams of FIG. 3 represent the envelopes of the oscillatory relative movements of the welding parts. The two diagrams on the right-hand side of FIG. 3 represent the behaviour of X and Y amplitudes during free and uncontrolled attenuation (i.e. without active braking) in a conventional vibration welding method. As shown the attenuation times t(aus) are 730 ms and, respectively, 735 ms.

Active braking of the oscillatory relative movements of the welding part allows to reduce the attenuation times t(aus) to 61 ms and, respectively, 45 ms as indicated in the left-hand diagrams of FIG. 3.

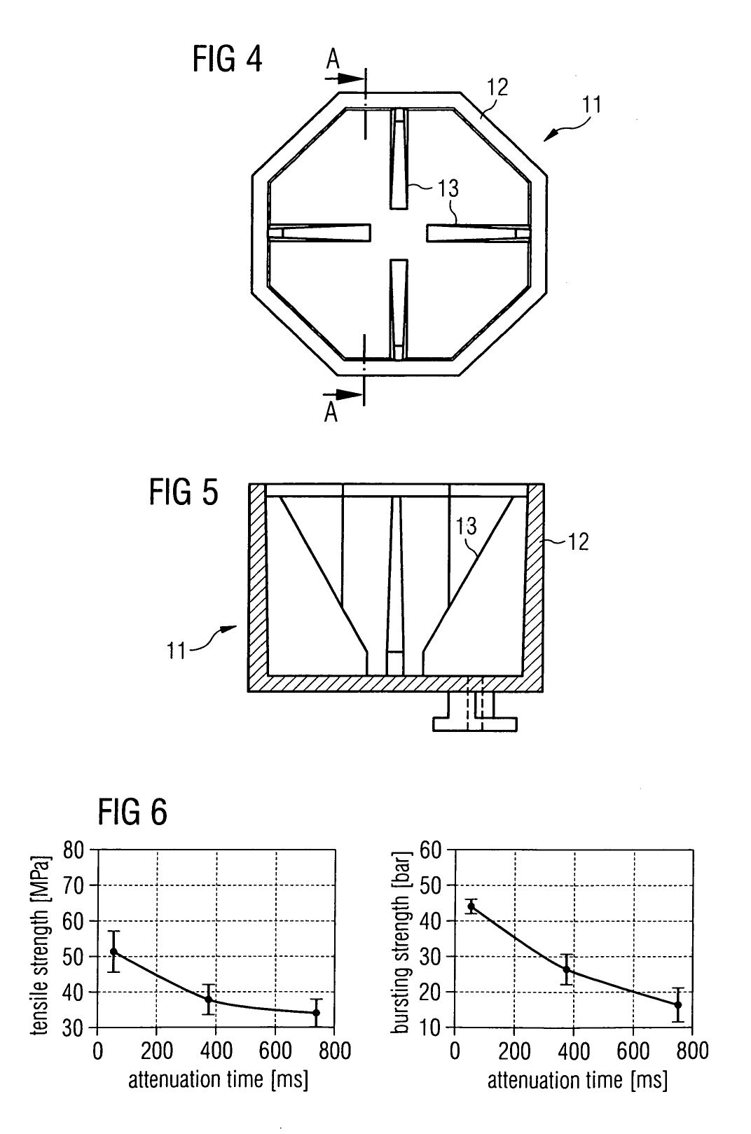

As explained above reduction of the attenuation times during vibration welding result in significantly improved mechanical properties of the welding seam of the welding parts, in particular in increased tensile strength and increased bursting strength. This was proven by tests performed by the inventors in connection with biaxially welded sample parts made of short fibre reinforced polyamide (PA66-GF30). Such a sample part 11 has been shown in FIGS. 4 and 5. The sample part 11 comprises a cup-shaped housing 12 of octagonal peripheral shape and including radially extending stiffening webs 13.

Short-time tensile tests on band-shaped samples of such sample parts 11 revealed that the tensile strength obtained with an attenuation time of about 50 ms was up to about 40% more than that of reference sample parts which were made by a vibration welding machine with “free” attenuation of the oscillatory relative movements of the welding parts. The left-hand diagram of FIG. 6 represents the relationshhip between the tensile strength and the attenuation time.

Integral bursting tests on sample parts 11 have yielded similar results. Reduction of the attenuation time has resulted also in increase of the bursting strength of up to 40%. The relationship between the bursting strength and the attenuation time is shown in the right-hand diagram of FIG. 6.

As mentioned above active braking of the oscillatory relative movements of the welding parts may be obtained in simple electromagnetic resonance vibration systems by phase reversal of the vibration excitation, see the left-hand diagram of FIG. 6. Vibration systems including control means for controlling amplitude or position (linear vibrations) or path (biaxial vibrations) of the vibration head merely require a software program which provides for quickly controlling the amplitude or position or path of the vibration head so as to be reduced to a zero-value.

In mechanical vibration systems including a motor-drive for the vibration head, active braking may be obtained by having control means acting upon the motor-drive. In this case mechanical brakes for the welding tool, the vibration head, or the motor-drive may be used. When a servomotor drive is used, active braking of the vibration operation may be obtained by controlling the servomotor-drive via desired value commands.

The method of the present invention may be used to weld welding parts of same or similar thermoplastic materials or for welding a welding part of a thermoplastic material and a welding part of another meltable material. For example one welding part may be made of a (partly) cross-linked plastic material (duroplastic material or thermoplastic elastomeric material) while the other welding part may be made of a thermoplastic material or another material such as wood, fibre material, etc.

1. A method for vibration welding of welding parts comprising the steps of:
melting welding zones of the welding parts by oscillatory relative movements of the welding parts while they frictionally engage each other; and
cooling any molten material of the welding parts thereafter to join them in a welding seam, wherein the oscillatory relative movements of the welding parts are generated by a driven vibration head and are attenuated within a predetermined attenuation time for terminating the welding operation, wherein the attenuation time of the oscillatory relative movements of the welding parts is reduced in a controlled manner as compared to an attenuation time resulting from uncontrolled free attenuation of the oscillatory relative movements of the welding parts so as to improve the mechanical properties of the welding seam.

2. The method of claim 1 wherein said predetermined attenuation time is less than 100 ms.

3. The method of claim 1 wherein said predetermined attenuation time is less than 50 ms.

4. The method of claim 1 wherein said predetermined attenuation time is obtained by the step of active braking of the oscillatory relative movements of the welding parts.

5. The method of claim 4 wherein said vibration head forms part of an electromagnetic resonance vibration system including vibration excitation means for exciting vibrations of a predetermined phase, and in which said active braking step of the oscillatory relative movements of the welding parts is obtained by a reversal of said predetermined phase of the vibrations of said excitation means.

6. The method of claim 4 wherein said vibration head forms part of an electromagnetic resonance vibration system which includes control means for controlling position or path or amplitude of oscillatory movements of the vibration head, wherein said active braking step of the oscillatory relative movements of the welding parts is obtained by controlling at least one position and path of amplitude so as to be reduced to a zero-value.

7. The method of claim 4 wherein said vibration head forms part of a mechanical vibration system including a motor drive with control means, wherein said active braking step of the oscillatory relative movements of the welding parts is generated by causing the control means to act upon said motor drive.

8. The method of claim 4 wherein the vibration head forms part of a mechanical vibration system including a motor drive with brake means, wherein said active braking step of the oscillatory relative movements of the welding parts being obtained by said brake means for braking a moving member of said mechanical vibration system.

9. The method of claim 1 wherein said oscillatory relative movements of the welding parts comprise linear oscillatory relative movements.

10. The method of claim 1 wherein said oscillatory relative movements of the welding parts comprise biaxial oscillatory relative movements.

11. The method of claim 1, wherein said method is used to weld welding parts of same or similar thermoplastic materials or for welding a welding part of a thermoplastic material and a welding part of another meltable material.
